(19) United States
(12) Patent Application Publication
(10) Pub. No.: US 2008/0198452 A1
(43) Pub. Date: Aug. 21, 2008

(54) Real-image variable magnification finder optical system and imaging apparatus

(75) Inventor: Katsuya Fujihara, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/071,208

(22) Filed: Feb. 19, 2008

(30) Foreign Application Priority Data
Feb. 21, 2007 (JP) 2007-041066

(51) Int. Cl. G02B 15/14

(52) U.S. Cl. 359/432

(57) ABSTRACT

A real-image variable magnification finder optical system includes, in the order from an object side, an objective lens group having a positive refractive power, a member for forming an erect image from an image inverted by the objective lens group, and an eyepiece lens having positive refractive power. The objective lens group includes, in the order from an object side, a first lens group having a negative refractive power and a second lens group having positive refractive power to perform zooming and compensate a diopter change caused by the zooming by moving the first lens group and the second lens group in an optical axis direction. The objective lens satisfies a predetermined condition.

### BACKGROUND OF THE INVENTION

1. Field of the Invention

The present invention relates to a novel real-image variable magnification finder optical system and an imaging apparatus. More particularly, it relates to a small-sized, satisfactory-optical performance real-image variable magnification finder optical system suitable for mounting to cameras such as digital still cameras, as well as to an imaging apparatus equipped with the real-image variable magnification finder optical system.

2. Description of Related Art

In a camera composed of a photo-taking optical system having a zooming function and a real-image finder optical system that are configured as separate systems, a zooming function adaptable to variations in a shooting angle of view has been also provided to the real-image finder optical system. As such a finder optical system, various types of real-image variable magnification finders ensuring satisfactory appearance of a field frame have been proposed.

As a real-image variable magnification finder optical system, those described in Japanese Unexamined Patent Application Publications No. 2-173713 and No. 6-102454 are known. Each of the known real-image variable magnification finder optical systems has an objective optical lens system including a first lens group having a positive refractive power, a second lens group having a negative refractive power, a third lens group having a positive refractive power and a fourth lens group having a positive refractive power, thereby providing a variable magnification ratio of about 200 to 400 percent.

Rapid advancement has been made in realization of more compact digital cameras in recent years, and with this advancement, still more miniaturization with respect to the finder optical system has been also in demand.

Therefore, the refractive power of each lens group needs to be intensified for realization of more miniaturization. However, it is quite difficult to make satisfactory compensation for various types of aberrations occurring in each lens group, while maintaining a predetermined variable magnification ratio. In addition, a diopter deviation supposed to be the main cause of a degradation of performance occurs depending on component tolerances or variations occurring at the time of lens incorporation. Thus, modification such as those for improvement in a component accuracy and additional installation of an adjusting mechanism become required, thereby resulting in a cost increase.

### SUMMARY OF THE INVENTION

The present invention addresses the above-identified circumstances to provide: (1) a real-image variable magnification finder optical system that realizes a miniaturized configuration, and at the same time, has satisfactory optical performances, particularly, ensuring that a diopter deviation is hard to occur; and (2) an imaging apparatus equipped with the real-image variable magnification finder optical system.

A real-image variable magnification finder optical system according to an embodiment of the present invention includes, in the order from an object side, an objective lens group having a positive refractive power, a member for forming an erect image from an image inverted by the objective lens group, and an eyepiece lens having a positive refractive power. The erect image forming member may be a prism, a mirror, or the like. The objective lens group includes, in the order from an object side, a first lens group having a negative refractive power and a second lens group having a positive refractive power to perform zooming and compensate a diopter change caused by the zooming by moving the first lens group and the second lens group in an optical axis direction. The objective lens satisfies the following conditional expressions (1) and (2).

1.05<f2/ΔL<1.25 (1)

1.7<|f1|/fw<2.2 (2)

where f1 is a focal length of the first lens group, f2 is a focal length of the second lens group, fw is a composite focal distance of the first and the second lens groups with respect to a wide-angle end, and ΔL is an amount of movement of the second lens group during the zooming.

An imaging apparatus according to another embodiment of the present invention includes the real-image variable magnification finder optical system by one embodiment of the present invention, and an image-forming optical system having an incidence optical path different from that of the real-image variable magnification finder optical system and adapted to effect imaging of a subject image observed through the real-image variable magnification finder optical system.

According to embodiments of the present invention, it is possible to prevent the occurrence of a diopter difference and accomplish miniaturization together with satisfactory optical performances.

### BRIEF DESCRIPTION OF THE DRAWINGS

FIGS. 1 to 4 show a real-image variable magnification finder optical system of a first embodiment of the present invention, specifically, FIG. 1 is a schematic view showing an optical configuration, and FIGS. 2 to 4 are respectively aberration graphs according to a numerical example 1 provided by application of actual numeric values to the first embodiment, where graphs in FIG. 2 are of spherical aberration, astigmatism and distortion aberration with respect to a wide-angle end, graphs in FIG. 3 are of spherical aberration, astigmatism and distortion aberration with respect to a mid-focal length position, and graphs in FIG. 4 are of spherical aberration, astigmatism and distortion aberration with respect to a telephoto end;

FIGS. 5 to 8 illustrate a real-image variable magnification finder optical system according to an second embodiment of the present invention, specifically, FIG. 5 is a schematic view showing an optical configuration, FIGS. 6 to 8 are respectively aberration graphs according to a numerical example 2 provided by application of actual numeric values to the second embodiment, where graphs in FIG. 6 are of spherical aberration, astigmatism and distortion aberration in a wide-angle end, graphs in FIG. 7 are of spherical aberration, astigmatism and distortion aberration in a mid-focal length position, and graphs in FIG. 8 are of spherical aberration, astigmatism and distortion aberration in a telephoto end;

FIGS. 9 to 12 illustrate a real-image variable magnification finder optical system according to a third embodiment of the present invention, specifically, FIG. 9 is a schematic view showing an optical configuration, FIGS. 10 to 12 are respectively aberration graphs according to a numerical example 3 provided by application of actual numeric values to the third embodiment, where graphs in FIG. 10 are of spherical aberration, astigmatism and distortion aberration in a wide-angle end, graphs in FIG. 11 are of spherical aberration, astigmatism and distortion aberration in a mid-focal length position, and graphs in FIG. 12 are of spherical aberration, astigmatism and distortion aberration in a telephoto end;

FIG. 13 is a schematic perspective view showing a real-image variable magnification optical finder system applying an illustrative embodiment of the present invention; and

FIG. 14 is a schematic perspective view showing one embodiment provided by application of an imaging apparatus to a camera.

### DETAILED DESCRIPTION OF THE EMBODIMENTS

Hereinafter, embodiments of a real-image variable magnification finder optical system and an imaging apparatus according to embodiments of the present invention are described with reference to drawings.

Firstly, the real-image variable magnification finder optical system of one embodiment of the present invention is described.

The real-image variable magnification finder optical system of an embodiment of the present invention includes, in the order from an object side, an objective lens group having a positive refractive power, a member (such as a prism and a mirror) for forming an erect image from an image inverted by the objective lens group, and an eyepiece having a positive refractive power. The objective lens group includes, in positions in the order from the side of the object, a first lens group having a negative refractive power and a second lens group having a positive refractive power to perform zooming and compensate a dioper change caused by zooming by moving the first lens group and the second lens group in an optical axis direction, and the following conditional expressions (1) and (2) are satisfied.

1.05<f2</ΔL<1.25 (1)

1.7<|f1|/fw<2.2 (2)

where f1 is a focal length of the first lens group, f2 is a focal length of the second lens group, fw is a composite focal distance of the first and the second lens groups with respect to a wide-angle end, and ΔL is an amount of movement of the second lens group during the zooming.

Thus, the real-image variable magnification finder optical system of an embodiment of the present invention makes it possible to realize miniaturization, and at the same time, provide satisfactory optical performances ensuring that a diopter deviation is hard to occur.

The conditional expression (1) is to show a condition adapted to define a ratio of the focal length of the second lens group to the amount of movement of the second lens group during the zooming.

If falling below the lower limit of the conditional expression (1), a longitudinal magnification of the second lens group becomes greater, so that the diopter change with component tolerances and manufacturing appears significantly. As a result, an improvement in a component accuracy and additional installation of an adjusting mechanism are required, which leads to an increase in cost.

Conversely, if exceeding the upper limit of the conditional expression (1), the refractive power of the first lens group becomes smaller, so that an overall length in a wide-angle end increases and a finder unit becomes large because of increasing the amount of movement of the first lens group during the zooming.

Accordingly, the satisfaction of the conditional expression (1) results in an optimization of a rational longitudinal magnification of the second lens group, whereby realizing miniaturization, together with a reduction in diopter variations with the component tolerances and the manufacturing deviations.

The conditional expression (2) is to define a ratio of the focal length of a first lens group G1 to the focal length of the objective lens group with respect to the wide-angle end, and limits the refractive power of the first lens group. With a falling below a lower limit of the conditional expression (2), the refractive power of the first lens group becomes larger, resulting in a difficulty in compensating off-axial aberrations, particularly, a coma aberration and an image plane curvature. In addition, it becomes difficult to suppress a negative distortion aberration at the wide-angle end.

Conversely, if exceeding the upper limit of the conditional expression (2), the refractive power of the second lens group becomes smaller, so that the amount of movement of the second lens group during the zooming is increased thereby to result in increasing the overall length.

Accordingly, the satisfaction of the conditional expression (2) enables miniaturization, and also, maintains satisfactory optical performances.

In the real-image variable magnification finder optical system according to one embodiment of the present invention, it is preferable that the above first lens group and the above second lens group are both configured with a single plastic lens. It is also preferable that an object-side surface and an observer-side surface of each plastic lens are both aspheric.

This provides advantages of reducing the number of components, in addition to realization of miniaturization in such a manner as to reduce the overall length, resulting in cost reduction. Also, the finder optical system formed by a plastic lens enables easily both surface of the object-side and the observer-side to be aspheric. Thus, each aberration will be compensated easily.

Specific embodiments of the real-image variable magnification finder optical system of embodiments of the present invention, together with numerical examples provided by applications of actual numeric values to the specific embodiments, are now described with reference to drawings and tables.

An aspherical surface is introduced in each of the embodiments, where the aspherical shape is to be defined by an expression 1 shown below.

$$X = \frac{{H}^{2} / R}{1 + {\{ 1 - ( 1 + k ) \times {( 1 / R )}^{2} \times {H}^{2} \}}^{1 / 2}} + {AH}^{4} + {BH}^{6} + {CH}^{8} + {DH}^{10} \qquad [ Expression 1 ]$$

where X is a depth from a tangential plane with respect to a surface vertex, R is a paraxial radius of curvature of a surface, k is a conical constant, H is a height from the optical axis, A is a fourth-order aspherical coefficient, B is a sixth-order aspherical coefficient, C is an eighth-order aspherical coefficient, and D is a tenth-order aspherical coefficient.

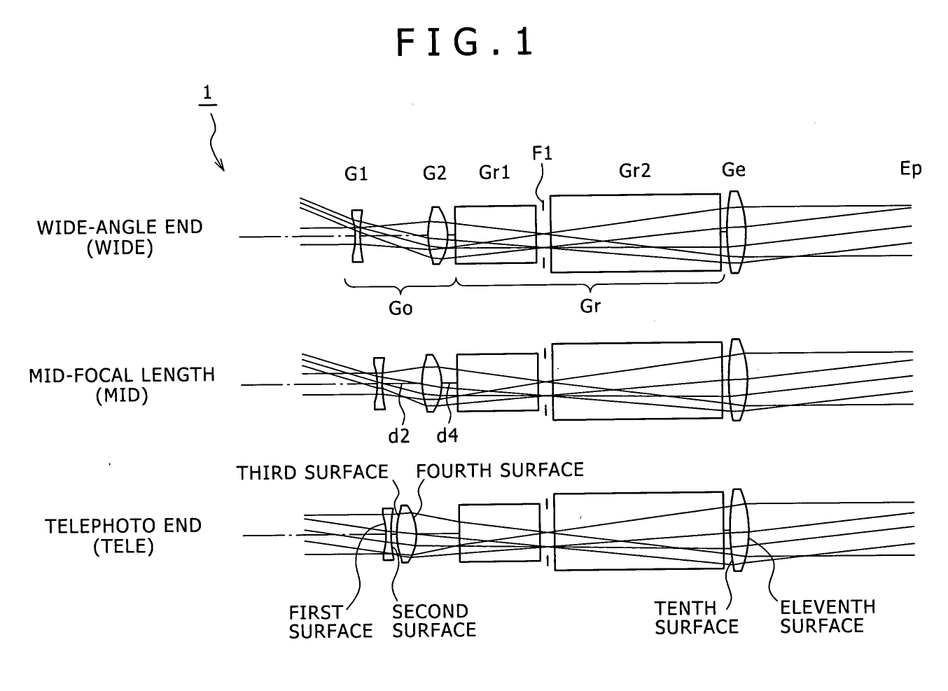

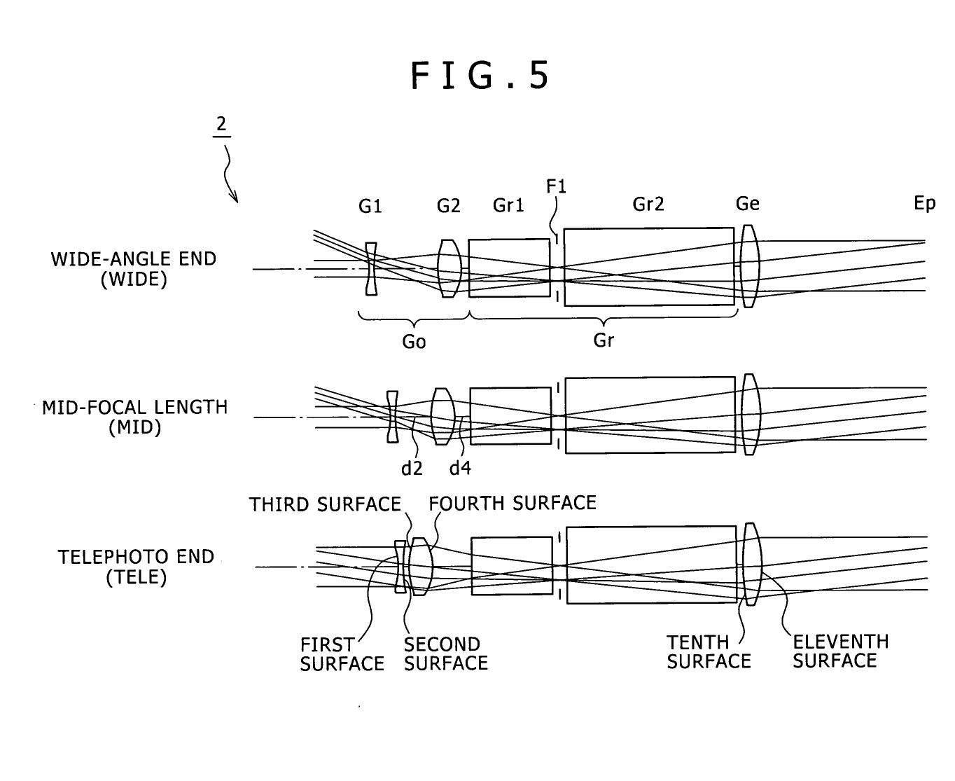

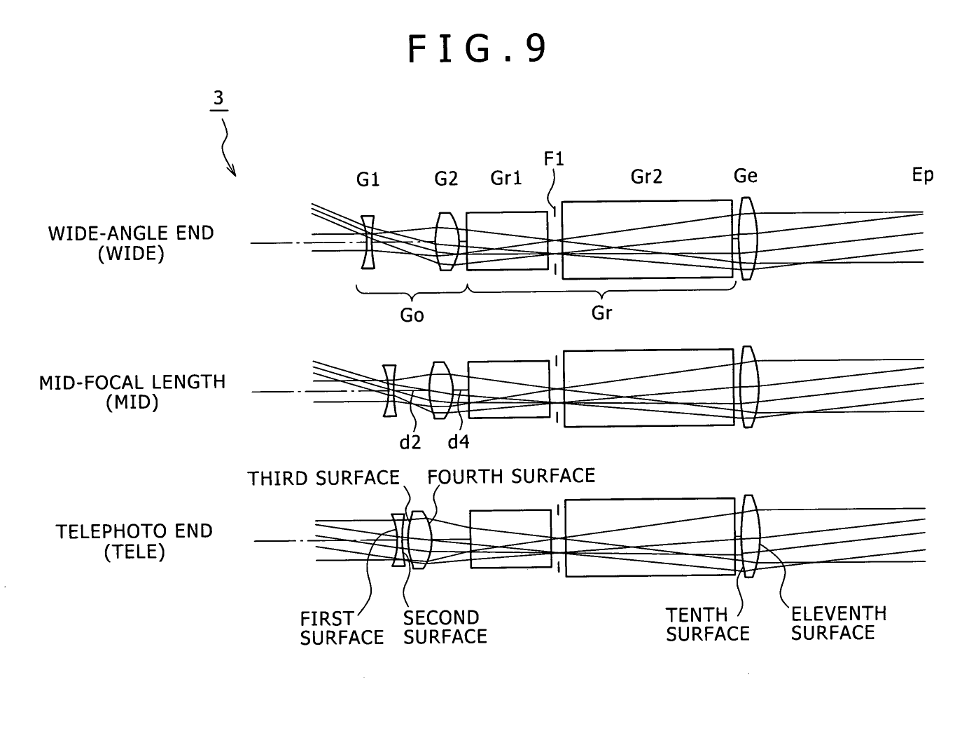

FIGS. 1 to 4 show a real-image variable magnification finder optical system according to a first embodiment 1 of the present invention. FIGS. 5 to 8 show a real-image variable magnification finder optical system according to a second embodiment 2 of the present invention. FIGS. 9 to 12 show a real-image variable magnification finder optical system according to a third embodiment 3 of the present invention.

As shown in FIGS. 1, 5 and 9, the real-image variable magnification finder optical system according to the embodiments 1, 2, and 3 of the present invention includes, positioned in the order from an object side toward an observer, an objective lens group Go having a positive refractive power, an erect image forming member Gr adapted to form an erect image from an image image-formed by the objective lens group Go, and an eyepiece lens Ge having a positive refractive power for observation of the erect image. It is noted that an upper stage, a middle stage and a lower stage in FIGS. 1, 5 and 9 respectively show a wide-angle position(maximum wide-angle state), a mid-focal length position and a telephoto position (maximum telephoto state).

In each of the embodiments 1, 2 and 3, the objective lens group Go includes, in positions in the order from the object side toward the observer, a first lens group G1 composed of a single lens and having a negative refractive power, and a second lens group G2 composed of a single lens and having a positive refractive power. A zooming and a compensation for the diopter change caused by the zooming are effected by allowing the first lens group G1 and the second lens group G2 to be moved on the optical axis. The erect image forming member Gr includes, positioned in the order from the object side toward the observer, a first member Gr1 and a second member Gr2. A field frame F1 is located between the first member Gr1 and the second member Gr2, causing an intermediate image obtained by the objective lens group Go to be imaged in the vicinity of the field frame F1. The erect image forming member Gr has more than one reflection plane located with an imaging position of the intermediate image between, and these reflection planes are adapted to form an optical plane of the erect image, allowing the erect image forming member to have an effect of making an erect image by subjecting the optical path to bending in the course of the optical path.

Various numerical lens data of a numerical example 1 provided by application of actual numeric values to a variable magnification lens 1 according to the first embodiment are listed in Table 1 shown below. In Table 1 and the subsequent tables listing various numerical lens data, “2ω” indicates an angle of view, “Si” indicates a surface number given to the i-th surface counting from the object side, “Ri” indicates a radius of curvature of the i-th surface, “di” indicates an on-axial surface space between the i-th surface counting from the object side and the i+1-th surface, “ni” indicates a refractive index with respect to a d-line (whose wavelength is 587.6 nm (nanometer)) of a glass material having the i-th surface (Si) on the object side, and “υi” indicates an Abbe number with respect to the d-line of the glass material having the i-th surface (Si) on the object side, respectively. In addition, with respect to “Si”, “*” indicates that the surface is aspheric. With respect to “Ri”, “ ” indicates that the surface concerned is plane. With respect to “di”, “(Di)” indicates that the surface space concerned is variable.

TABLE 1
2ω = 48.4°~18.0°

| Si | Ri | di | ni | vi |
|---|---|---|---|---|
| 1* | −4.9125 | 0.5 | 1.5826 | 29.0 |
| 2* | 23.5425 | D2 | | |
| 3* | 4.6131 | 1.83810789 | 1.5247 | 56.2 |
| 4* | −4.2778 | D4 | | |
| 5 | ∞ | 7.47325702 | 1.5247 | 56.2 |
| 6 | ∞ | 0.5 | | |
| 7 | INTERMEDIATE | 0.8 | | |
| | IMAGING POSITION | | | |
| 8 | ∞ | 15.4 | 1.5247 | 56.2 |
| 9 | ∞ | 0.8 | | |
| 10* | 18.939 | 1.6 | 1.5247 | 56.2 |
| 11* | −9.867 | 15 | | |
| 12 | EYEPOINT | | | |

The both surfaces (the first surface and the second surface) of a negative lens constituting the first lens group G1 of the objective lens group Go and the both surfaces (the third surface and the fourth surface) of a positive lens constituting the second lens group G2 thereof are aspheric. The both surfaces (the tenth surface and the eleventh surface) of the eyepiece lens Ge are also aspheric. The fourth-, the sixth-, the eighth-, and the tenth-order aspherical coefficients A, B, C and D of each surface of the numerical example 1 are listed in Table 2, together with the conical constants k. It is noted that in Table 2 and the subsequent tables listing the aspherical coefficients, “E-i” represents an exponential notation with a base ten number, in other words, “10-i”, and, “0.12345E-05” shows “0.12345×10−5”, for instance.

TABLE 2

| Si | k | A | B | C | D |
|---|---|---|---|---|---|
| 1* | −3.84 | 3.41E−03 | −8.12E−04 | 7.32E−05 | 0.00E+00 |
| 2* | 106.84 | 4.36E−03 | −8.41E−04 | 1.19E−05 | 0.00E+00 |
| 3* | −0.81 | −2.87E−03 | 1.86E−05 | −3.42E−05 | −3.84E−06 |
| 4* | −0.36 | 1.93E−03 | −1.09E−04 | −1.01E−05 | −5.32E−06 |
| 10* | 21.27 | −7.18E−04 | −1.77E−05 | 0.00E+00 | 0.00E+00 |
| 11* | 0.32 | −2.30E−05 | 1.11E−06 | −9.60E−07 | 1.14E−07 |

In a real-image variable magnification finder optical system 1 according to the first embodiment, the zooming and the compensation for the diopter change caused by the zooming are effected by allowing the first lens group G1 and the second lens group G2 in the objective lens group Go to be moved on the optical axis. Thus, the surface space d2 (D2) and d4 (D4) are variable. The numeric values of the surface space d2 (D2) and d4 (D4) with respect to each of the wide-angle end, the mid-focal length position and the telephoto end in the numeral example 1 are listed in Table 3.

TABLE 3

| | WIDE-ANGLE | MID-FOCAL | TELEPHOTO |
|---|---|---|---|
| di | END | LENGTH | END |
| D2 | 6.180 | 3.575 | 0.364 |
| D4 | 0.700 | 1.533 | 4.215 |

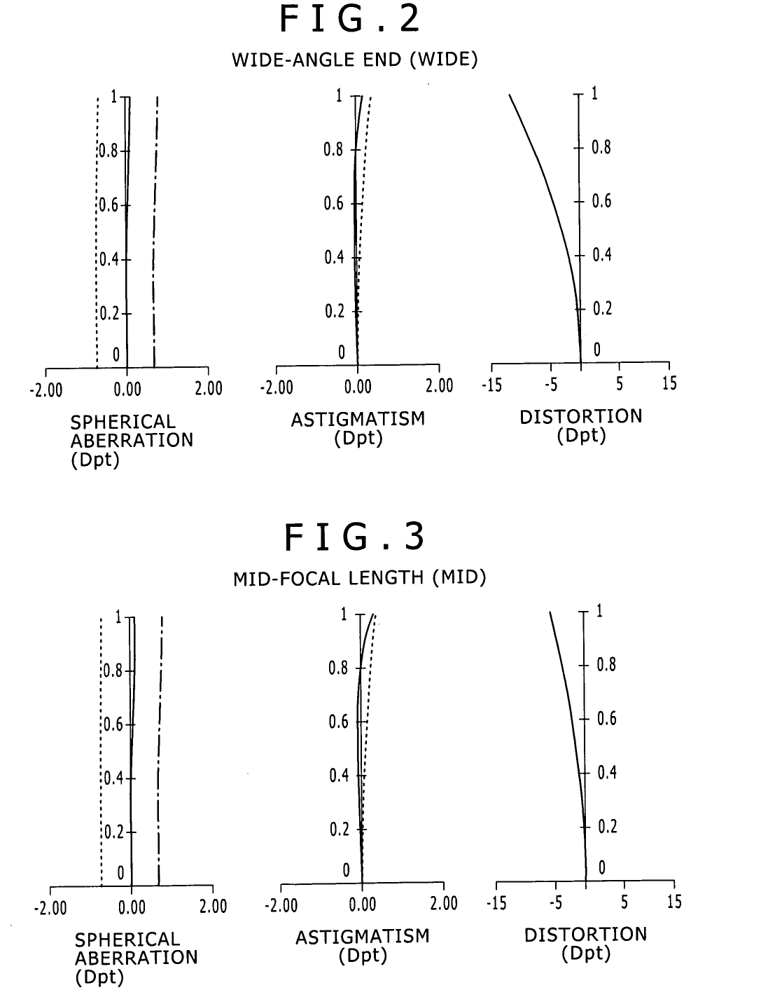

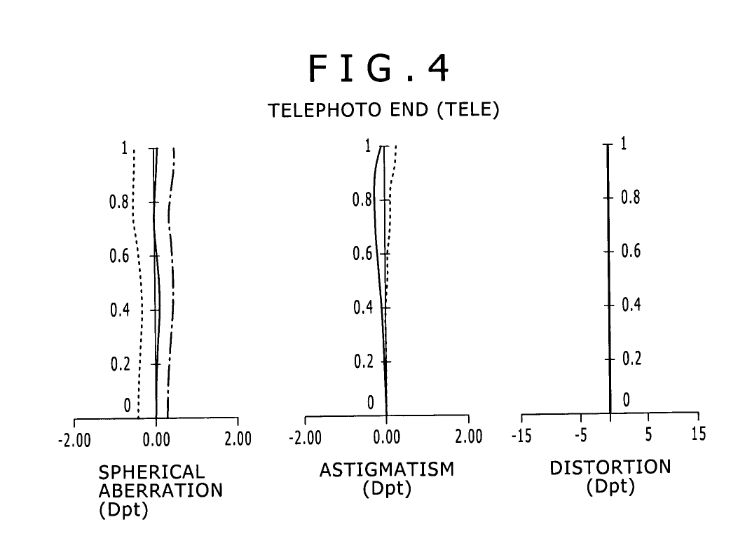

FIGS. 2 to 4 are aberration graphs of the numerical example 1, respectively. Graphs in FIG. 2 are of spherical aberration, astigmatism and distortion aberration with respect to the wide-angle end, graphs in FIG. 3 are of spherical aberration, astigmatism and distortion aberration with respect to the mid-focal length position, and graphs in FIG. 4 are of spherical aberration, astigmatism and distortion aberration with respect to the telephoto end. It is noted that in the spherical aberration graphs, a solid line indicates values with respect to an e-line (whose wavelength is 546.7 nm), a broken line indicates values with respect to a C-line (whose wavelength is 656.3 nm), and a chain line indicates values with respect to an F-line (whose wavelength is 486.1 nm). It is also noted that in the astigmatism graphs, a solid line indicates values with respect to a tangential image plane, and a broken line indicates values with respect to a sagittal image plane.

Various numerical lens data of a numerical example 2 provided by application of actual numeric values to a variable magnification lens 2 according to the second embodiment are listed in Table 4 shown below.

TABLE 4
2ω = 48.4°~18.0°

| Si | Ri | di | ni | vi |
|---|---|---|---|---|
| 1* | −4.8933 | 0.5 | 1.5826 | 29.0 |
| 2* | 17.3442 | D2 | | |
| 3* | 4.6975 | 2.187 | 1.5247 | 56.2 |
| 4* | −4.0295 | D4 | | |
| 5 | ∞ | 7.473 | 1.5247 | 56.26 |
| 7 | INTERMEDIATE | | | |
| | IMAGING POSITION | 0.8 | | |
| 8 | ∞ | 15.4 | 1.5247 | 56.2 |
| 9 | ∞ | 0.8 | | |
| 10* | 18.604 | 1.6 | 1.5247 | 56.2 |
| 11* | −9.950 | 15 | | |
| 12 | EYEPOINT | | | |

The both surfaces (the first surface and the second surface) of the negative lens constituting the first lens group G1 of the objective lens group Go and the both surfaces (the third surface and the fourth surface) of the positive lens constituting the second lens group G2 thereof are aspheric. The both surfaces (the tenth surface and the eleventh surface) of the eyepiece Ge are also aspheric. The fourth-, the sixth-, the eighth-, and the tenth-order aspherical coefficients A, B, C and D of each surface with respect to the numeral example 2 are listed in Table 5, together with the conical constants k.

TABLE 5

| Si | k | A | B | C | D |
|---|---|---|---|---|---|
| 1* | −2.92 | 3.01E−03 | −9.09E−04 | 1.05E−04 | 0.00E+00 |
| 2* | 54.45 | 2.76E−03 | −8.40E−04 | 2.55E−05 | 0.00E+00 |
| 3* | −1.16 | −3.29E−03 | −5.36E−06 | −3.72E−05 | −4.83E−06 |
| 4* | −0.28 | 1.63E−03 | −5.35E−05 | −2.90E−05 | −2.91E−06 |
| 10* | 20.47 | −6.80E−04 | −1.46E−05 | 0.00E+00 | 0.00E+00 |
| 11* | 0.22 | 5.08E−06 | 2.36E−06 | −7.77E−07 | 1.11E−07 |

In a real-image variable magnification finder optical system 2 according to the second embodiment, the zooming and the compensation for the diopter change caused by the zooming are effected by allowing the first lens group G1 and the second lens group G2 in the objective lens group Go to be moved on the optical axis. Thus, the surface space d2 (D2) and that d4 (D4) are supposed to be variable. As such, numeric values of the surface space d2 (D2) and that d4 (D4) with respect to each of the wide-angle end, the mid-focal length position and the telephoto end in the numeral example 2 are listed in Table 6.

TABLE 6

| | WIDE-ANGLE | MID-FOCAL | TELEPHOTO |
|---|---|---|---|
| di | END | LENGTH | END |
| D2 | 5.774 | 3.348 | 0.358 |
| D4 | 0.700 | 1.582 | 4.421 |

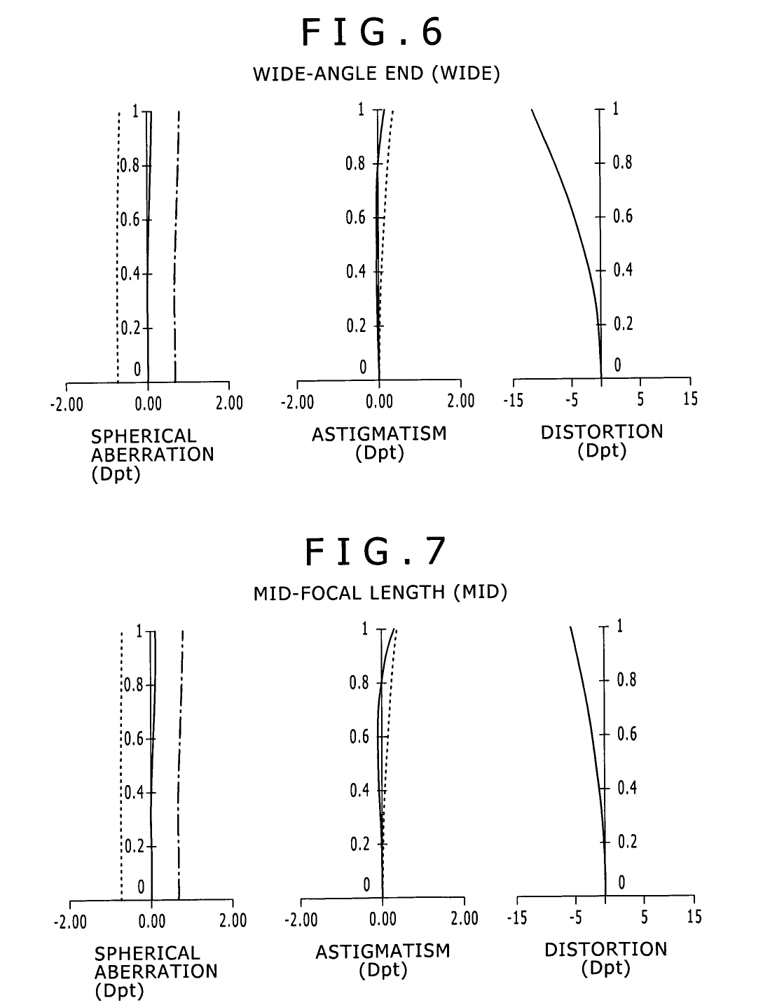

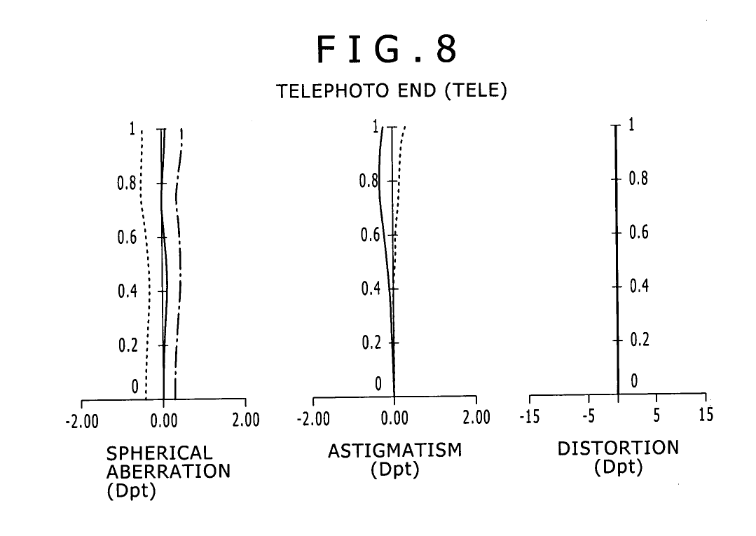

FIGS. 6 to 8 are respectively aberration graphs of the above numeral example 2. Graphs in FIG. 6 are of spherical aberration, astigmatism and distortion aberration with respect to the wide-angle end, graphs in FIG. 7 are of spherical aberration, astigmatism and distortion aberration with respect to the mid-focal length position, and graphs in FIG. 8 are of spherical aberration, astigmatism and distortion aberration with respect to the telephoto end. It is noted that in the spherical aberration graphs, a solid line indicates values with respect to an e-line (whose wavelength is 546.7 nm), a broken line indicates values with respect to a C-line (whose wavelength is 656.3 nm), and a chain line indicates values with respect to an F-line (whose wavelength is 486.1 nm). It is also noted that in the astigmatism graphs, a solid line indicates values with respect to a tangential image plane, and a broken line indicates values with respect to a sagittal image plane.

Various numerical lens data of a numerical example 3 provided by application of actual numeric values to a variable magnification lens 3 according to the third embodiment are listed in Table 7 shown below.

TABLE 7
2ω = 48.4°~18.0°

| Si | Ri | di | ni | vi |
|---|---|---|---|---|
| 1* | −4.7186 | 0.5 | 1.5826 | 29.0 |
| 2* | 13.7361 | D2 | | |
| 3* | −4.4633 | 2.053 | 1.5247 | 56.2 |
| 4* | −3.9710 | D4 | | |
| 5 | ∞ | 7.473 | 1.5247 | 56.2 |
| 6 | ∞ | 0.5 | | |
| 7 | INTERMEDIATE | 0.8 | | |
| | IMAGING POSITION | | | |
| 8 | ∞ | 15.4 | 1.5247 | 56.2 |
| 9 | ∞ | 0.8 | | |
| 10* | 19.182 | 1.6 | 1.5247 | 56.2 |
| 11* | −9.810 | 15 | | |
| 12 | EYEPOINT | | | |

The both surfaces (the first surface and the second surface) of the negative lens constituting the first lens group G1 of the objective lens group Go and the both surfaces (the third surface and the fourth surface) of the positive lens constituting the second lens group G2 thereof are aspheric. The both surfaces (the tenth surface and the eleventh surface) of the eyepiece lens Ge are also aspheric. The fourth-, the sixth-, the eighth-, and the tenth-order aspherical coefficients A, B, C and D of each surface with respect to the numeral example 3 are listed in Table 8, together with the conical constants K.

TABLE 8

| Si | k | A | B | C | D |
|---|---|---|---|---|---|
| 1* | −2.64 | 2.56E−03 | −9.19E−04 | 1.15E−04 | 0.00E+00 |
| 2* | 33.93 | 1.65E−03 | −8.00E−04 | 1.25E−05 | 0.00E+00 |
| 3* | −1.16 | −3.28E−03 | 3.96E−05 | −2.73E−05 | −4.91E−06 |
| 4* | −0.36 | 1.92E−03 | −9.40E−05 | −5.53E−06 | −5.48E−06 |
| 10* | 21.53 | −6.96E−04 | −1.73E−05 | 0.00E+00 | 0.00E+00 |
| 11* | 0.40 | 2.29E−06 | 8.37E−07 | −8.65E−07 | 1.04E−07 |

In a real-image variable magnification finder optical system 3 according to the third embodiment, the zooming and the compensation for the diopter change caused by the zooming are effected by allowing the first lens group G1 and the second lens group G2 in the objective lens group Go to be moved on the optical axis. Thus, the surface space d2 (D2) and that space d4 (D4) are variable. The numeric values of the surface space d2 (D2) and that space d4 (D4) with respect to each of the wide-angle end, the mid-focal length position and the telephoto end in the numeral example 3 are listed in Table 9.

TABLE 9

| | WIDE-ANGLE | MID-FOCAL | TELEPHOTO |
|---|---|---|---|
| di | END | LENGTH | END |
| D2 | 5.236 | 3.083 | 0.429 |
| D4 | 0.700 | 1.626 | 4.612 |

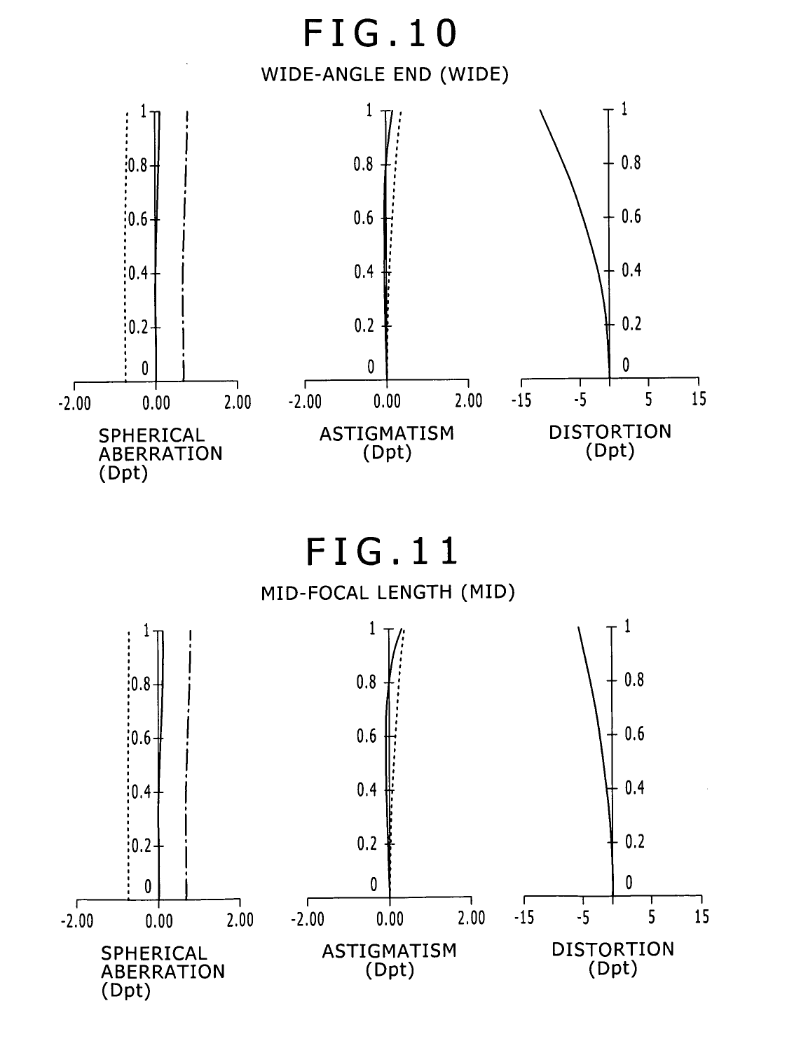

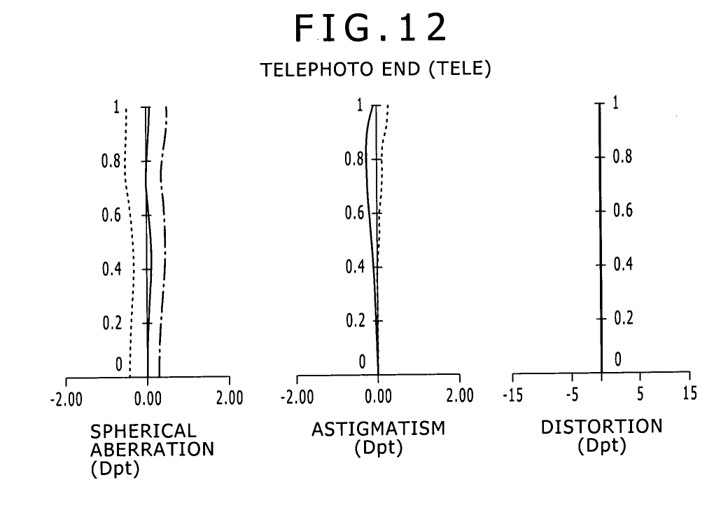

FIGS. 10 to 12 are respectively aberration graphs of the numerical example 3. Graphs in FIG. 10 are of spherical aberration, astigmatism and distortion aberration with respect to the wide-angle end, graphs in FIG. 11 are of spherical aberration, astigmatism and distortion aberration with respect to the mid-focal length position, and graphs in FIG. 12 are of spherical aberration, astigmatism and distortion aberration with respect to the telephoto end. It is noted that in the spherical aberration graphs, a solid line indicates values with respect to an e-line (whose wavelength is 546.7 nm), a broken line indicates values with respect to a C-line (whose wavelength is 656.3 nm), and a chain line indicates values with respect to an F-line (whose wavelength is 486.1 nm). It is also noted that in the astigmatism graphs, a solid line indicates values with respect to a tangential image plane, and a broken line indicates values with respect to a sagittal image plane.

Corresponding numeric values to each of the conditional expressions (1) and (2) in the numeral examples 1 to 3 are listed in Table 10.

TABLE 10

| CONDITIONAL | NUMERAL | NUMERAL | NUMERAL |
|---|---|---|---|
| EXPRESSION | EXAMPLE 1 | EXAMPLE 2 | EXAMPLE 3 |
| (1) f2/ΔL | 1.29 | 1.21 | 1.11 |
| (2) \|f1\|/fw | 2.08 | 1.95 | 1.79 |

As described above, according to embodiments of the present invention, it is possible to obtain the real image variable magnification finder optical system that provides the satisfactory optical performances, and ensures that high productivity is realized by reducing the diopter sensitiveness, while maintaining small size.

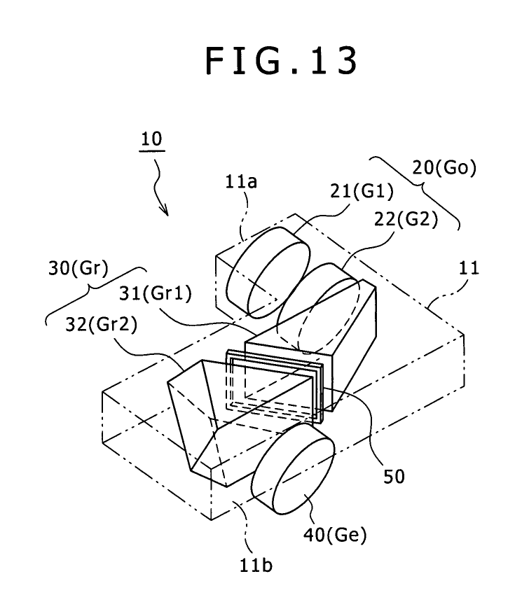

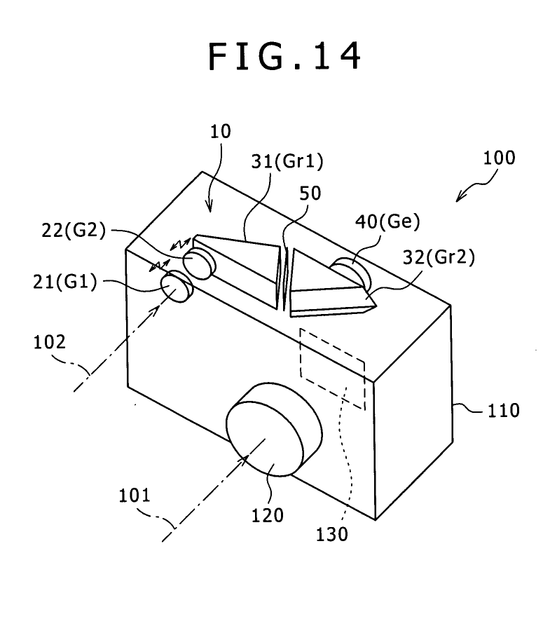

FIG. 13 shows one specific application of the real image variable magnification finder optical system of embodiments of the present invention to a real-image mode variable magnification finder. The finder 10 has a casing 11 taking an approximately L-like shape as viewed in plan, and in the casing 11, an objective lens group 20, a erect image forming member 30 and an eyepiece lens 40 are placed. The objective lens group 20 has a first lens group 21 composed of a single plastic lens, and the first lens group 21 faces to the front through a front-side opening 11a of the casing 11. The eyepiece lens 40 faces to the rear through a rear-side opening 11b of the casing.

Furthermore, the real-image forming member 30 composed of two prisms 31 (a first member) and 32 (a second member) which have a roof prism configuration is located between the objective lens 20 and the eyepiece lens 40 to cause a cranked optical path extending from the first lens group 21 of the objective lens group to the eyepiece lens 40 to be formed, which leads to more compact towards an optical axis direction. A field frame 50 (F1) is arranged in the vicinity of an intermediate imaging plane between the two prisms 31 and 32 to thereby limit a finder field range.

It is a matter of course that a structure of the specific application of the real-image variable magnification finder optical system of embodiments of the present invention is not limited to the finder 10 shown in FIG. 13.

An imaging apparatus of an embodiment of the present invention is now described.

The imaging apparatus of embodiments of the present invention includes a real-image variable magnification finder optical system and an optical imaging system having an incidence optical path different from that of the real-image variable magnification finder optical system and adapted to effect imaging of a subject image observed through the real-image variable magnification finder optical system. The real-image variable magnification finder optical system includes, in positions in the order from the side of an object, an objective lens group having a positive refractive power, an erect image forming member (such as a prism and a mirror) adapted to form an erect image obtained by the objective lens group, and an eyepiece lens having a positive refractive power. The objective lens group includes, in positions in the order from the side of the object, a first lens group having a negative refractive power and a second lens group having a positive refractive power to perform zooming and compensate a diopter change caused by the zooming by moving the first lens group and the second lens group in an optical axis direction, and conditional expressions (1) and (2) shown below are satisfied.

1.05<f2/ΔL<1.25 (1)

1.7<|f1|/fw<2.2

where f1 is a focal length of the first lens group, f2 is a focal length of the second lens group, fw is a composite focal distance of the first and the second lens groups with respect to a wide-angle end, and ΔL is an amount of movement of the second lens group during the zooming.

Thus, the real-image variable magnification finder optical system equipped with the imaging apparatus of embodiments of the present invention may realize small sized configuration, and at the same time, provides satisfactory optical performances ensuring that a diopter deviation is hard to occur. For that reason, the imaging apparatus of embodiments of the present invention enables satisfactory image-taking environments without causing diopter deviation of the finder, and at the same time, which leads to small sized configuration.

The imaging apparatus of embodiments of the present invention as described above may be configured in the lens shutter cameras and electronic still cameras, for instance.

As one embodiment of the imaging apparatus of the present invention, FIG. 14 shows a camera 100 by using the real-image variable magnification finder 10 shown in FIG. 13. The camera 100 shown is of a type applied to a digital still camera having an imaging device and a film loaded camera requiring use of silver salt films, for instance.

The camera 100 has a variable magnification lens 120 arranged, as an image-taking optical imaging system, on a front surface of a camera casing 110 so as to face to the front. The camera 100 also has a solid-state imaging device such as a CCD (Charge-Coupled Device) and a CMOS (Complementary Metal-Oxide-Semiconductor) or a silver salt film 130 arranged at an image plane position of the zoom lens 120 arranged in the camera casing 110. The camera body 100 further has the real-image variable magnification finder 10 arranged at a proper position, that is, an upper portion of the camera casing 110.

Then, a luminous flux incident on the zoom lens 120 through an image-taking incidence optical path 101 allows a subject image to be imaged on an imaging plane of the solid-state imaging device or the silver salt film 130, causing the subject image to be recorded on the solid-state imaging device or the silver salt film 130.

On the other hand, the same subject image passes through a finder optical path 102 approximately parallel to the image-taking incidence optical path 101, and thereby to reach the retina (not shown) of a photographer through a rear end aperture 11b (an eyepiece aperture) of the real-image variable magnification finder 10 located on a rear surface of the camera casing 110. As described above, the real-image variable magnification finder 10 leads to more miniaturization in the incidence optical axis direction to realization by adapting the two prisms 31 and 32 of the erect image forming member 30 (Gr) to effect bending of the optical path in the finder 10 so as to be cranked within a horizontal or vertical plane, and as a result, it is possible to reduce a thickness of the camera 100 employing the finder 10.

It is noted that the specific forms and structures of the various parts and the numeric values indicated in each of the embodiments and the above numeral examples are merely given as examples for implementation of embodiments of the present invention. It is therefore to be understood that the technical scope of the present invention should in no way be limited by the above.

The present application claims benefit of priority of Japanese patent Application No. 2007-41066 filed in the Japanese Patent Office on Feb. 21, 2007, the entire contents of which are incorporated herein by reference.

What is claimed is:

1. A real-image variable magnification finder optical system comprising, in the order from an object side:
an objective lens group having a positive refractive power;
a member for forming an erect image from an image inverted by the objective lens group; and
an eyepiece lens having a positive refractive power,
wherein,
the objective lens group includes, in the order from an object side, a first lens group having a negative refractive power and a second lens group having positive refractive power to perform zooming and compensate a diopter change caused by the zooming by moving the first lens group and the second lens group in an optical axis direction, and the following conditional expressions (1) and (2) are satisfied.
1.05<f2/ΔL<1.25 (1)
1.7<|f1|/fw<2.2 (2)
where
f1 is a focal length of the first lens group,
f2 is a focal length of the second lens group,
fw is a composite focal distance of the first and the second lens groups with respect to a wide-angle end, and
ΔL is an amount of movement of the second lens group during the zooming.

2. The real-image variable magnification finder optical system according to claim 1, wherein the first lens group and the second lens group are both composed of a single plastic lens, and an object-side surface and an observer-side surface of each of the plastic lenses are both aspheric.

3. An imaging apparatus comprising,
a real image type variable magnification finder optical system; and
an optical imaging system having an incidence optical path different from that of the real-image variable magnification finder optical system and adapted to effect imaging of a subject image observed through the real image type variable magnification finder optical system,
wherein the real-image variable magnification finder optical system includes, in positions in the order from an object side, an objective lens group having positive refractive power, a member for forming an erect image from an image inverted by the objective lens group, and an eyepiece lens having a positive refractive power, and
wherein the objective lens group includes, in the order from an object side, a first lens group having a negative refractive power and a second lens group having a positive refractive power to perform zooming and compensate a diopter change caused by the zooming by moving the first lens group and the second lens group in an optical axis direction, and the following conditional expressions (1) and (2) are satisfied.
1.05<f2/ΔL<1.25 (1)
1.7<|f1|/fw<2.2 (2)
where f1 is a focal length of the first lens group, f2 is a focal length of the second lens group, fw is a composite focal distance of the first and the second lens groups with respect to a wide-angle end, and ΔL is an amount of movement of the second lens group during the zooming.
